(19) United States
(12) Patent Application Publication
(10) Pub. No.: US 2009/0190254 A1
(43) Pub. Date: Jul. 30, 2009

(54) MICROMACHINED MOVER

(75) Inventors: Zoran Jandric, Pittsburgh, PA (US); Patrick B. Chu, Wexford, PA (US); Mark D. Bedillion, Allison Park, PA (US)

Correspondence Address: SEAGATE TECHNOLOGY LLC;C/O WESTMAN, CHAMPLIN & KELLY, P.A., SUITE 1400, 900 SECOND AVENUE SOUTH, MINNEAPOLIS, MN, 55402-3244, US

(73) Assignee: Seagate Technology LLC, Scotts Valley, CA (US)

(21) Appl. No.: 12/021,561

(22) Filed: Jan. 29, 2008

(51) Int. Cl. G11B 5/33; H02N 11/00

(52) U.S. Cl. 360/110; 310/300; 310/10

(57) ABSTRACT

A micromachined mover includes a rotor substrate and a stator substrate. A suspension is configured to couple the rotor substrate to the stator substrate and allow relative movement therebetween in a plane of the substrates. The suspension is positioned on an interior portion of the substrates.

### BACKGROUND OF THE INVENTION

The present invention relates to movers used for information storage devices. More particularly, the present invention relates to movers which provide relative movement between substrates of information storage systems.

Disc based storage systems are well known and have been used to store information. In such systems, a disc storage medium is rotated while a transducing head is positioned radially across the disc surface. This allows the areas of the medium surface to be accessed for writing and reading information.

Another type of storage system uses substrates in which one substrate provides a storage medium and another substrate carries a transducing head. The substrates are microelectromechanical structures (MEMS) formed using micromachining techniques. Data can be read from, or written to, different areas of the medium substrate by providing relative movement between the two substrates. Various techniques are known to provide such movement and are shown, for example, in Walmsley et al., U.S. Pat. No. 6,882,019 titled “MOVABLE MICRO-ELECTROMECHANICAL DEVICE”; Ives, U.S. Pat. No. 6,925,047 titled “HIGH DENSITY DATA STORAGE MODULE”; Hartwell et al., U.S. Pat. No. 6,930,368 titled “MEMS HAVING A THREE-WAFER STRUCTURE”; Haeberle et al., U.S. Pat. No. 6,369,400 titled “MAGNETIC SCANNING OR POSITIONING SYSTEM WITH AT LEAST TWO DEGREES OF FREEDOM”; Fasen, U.S. Pat. No. 6,737,863 titled “ELECTROSTATIC DRIVE”; Brandt, U.S. Pat. No. 6,583,524 titled “MICRO-MOVER WITH BALANCED DYNAMICS”.

### SUMMARY OF THE INVENTION

A micromachined mover includes a rotor substrate and a stator substrate. A suspension is configured to couple the rotor substrate to the stator substrate and allow relative movement therebetween in a plane of the substrates. The suspension is positioned on an interior portion of the substrates.

### BRIEF DESCRIPTION OF THE DRAWINGS

FIG. 1A is a top plan view of a prior art mover, and FIG. 1B is a perspective view of a substrate of a different prior art mover.

FIG. 2 is a cross-sectional view of an example of a three-substrate probe device.

FIG. 3A is a top plan view and FIG. 3B is a perspective view of a substrate including a suspension for a mover arranged in accordance with the present invention.

FIG. 4 is a side cross-sectional view of a mover in accordance with the present invention including a centrally located suspension.

FIG. 5 is a side cross-sectional view of a mover in accordance with the present invention in which the suspension is located in a stator substrate.

FIG. 6A is a top plan view and FIG. 6B is a side view of substrates shown in FIG. 5.

FIG. 7 is a graph showing area efficiency versus length for a mover of the present invention and a prior art mover.

FIG. 8 is a top plan view of a substrate showing an alternative suspension configuration.

FIG. 9 is a top plan view of a substrate in accordance with the present invention which includes two suspension portions positioned at an interior of the substrate.

FIG. 10 is a side cross-sectional view of a mover showing positions of capacitive electrodes and actuator electrodes.

FIGS. 11A and 11B are side cross-sectional views showing some of the possible ways of sealing of the mover of the present invention.

FIG. 12 is a side cross-sectional view showing possible way of sealing of a stator substrate of the present invention.

FIGS. 13A and 13B are perspective exploded views showing an array of mover assemblies arranged as a storage system in accordance with the present invention.

### DETAILED DESCRIPTION OF ILLUSTRATIVE EMBODIMENTS

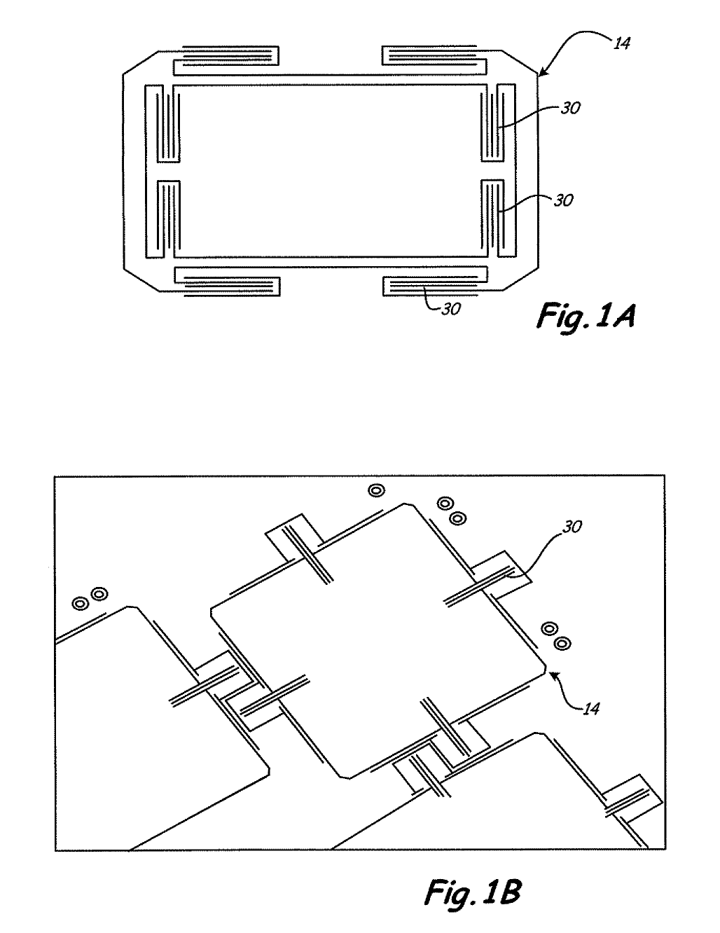

A MEMS-based mover consists of actuator and suspension structure. The suspension structure is typically compliant in-plane (x- and y-direction) and stiff out-of-plane (z-direction), while offering good decoupling of x- and y-axis motion. The actuator for the mover can be based on electrostatic, electro-thermal, or electromagnetic transduction. MEMS-based movers have been successfully built, with the majority having limited travel, normally about 1-30 μm. Examples of electrostatically actuated movers in a probe device are shown in FIGS. 1A and 1B. In this example, a rotor substrate 14 is supported by suspension structure 30.

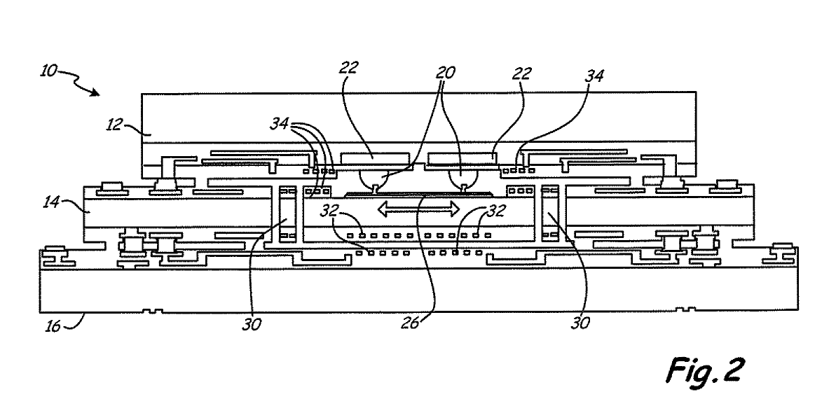

A cross-sectional view of a probe device 10 shown in FIG. 2 includes a three-substrate stack, arranged as: head 12, rotor 14, and stator 16. The head substrate 12 includes a head array 20 and the CMOS preamp electronics 22. The rotor substrate 14 includes the media area 26 that interacts with the head array 20; the suspension structure 30 that keeps media 26 suspended between head 20 and stator wafer 16 while offering decoupled motion in x- and y-directions and providing much higher out-of-plane than in-plane stiffness; and the set of electrodes 32 needed for the electrostatic actuator to provide motion. The stator substrate 16 holds the other set of electrodes 32 needed for the electrostatic actuator. In one configuration, a stack of two wafers consists only of stator and rotor wafers, to achieve same motion for a non-probe application. To detect the in-plane or out-of-plane motion of the mover, corresponding capacitive sensing electrodes 34 may be added to the head 12 and rotor substrates 14, or rotor 14 and stator substrates 16.

In some instances a larger stroke is required than that provided by the design of FIG. 2. The large stroke influences the design of the mover, and, as such, it indirectly influences the amount of area available for read/write, i.e. the area efficiency of the design.

Design of a MEMS mover for large in-plane stroke and large recording area is challenging for several reasons. Large strokes require long springs to meet stress and linearity requirements. For manufacturability, folded springs with a gimbal can provide uncoupled x and y in-plane motion. To meet the large stroke requirement and to move the large mass of the rotor (against operating vibration and shock), the electrostatic actuator must also generate large in-plane force. To compensate for undesirable parasitic z-force and to maintain z-stability while achieving large stroke, a large out-of-plane-to-in-plane stiffness ratio Kz/Kx of more than 400 is desirable. Out-of-plane stiffness is particularly important for probe storage because undesirable motion in z-direction would affect read/write physics. A large rigid gimbal structure would improve Kz/Kx but would reduce the media area. Given large folded springs and gimbal structure, a relatively small media area to chip area ratio is achieved.

The present invention provides a mover configuration to address the above challenges. The designs offer a significantly higher area efficiency.

Unlike the mover configuration discussed above where the moving platform is surrounded by the springs and gimbal, with the present invention the mover has its springs and gimbal in a central area and the springs and gimbal are surrounded by the moving platform. This “inverse” mechanical design leads to a significantly smaller gimbal, and thus more area for the media movable platform. The mover has a similar cross-section to that described above and is composed of three layers: a rotor substrate that has a moving platform with integrated media and actuation/position sensing electrodes suspended by springs and gimbal, which is sandwiched between a stator substrate that has a mating actuation (and sensing) electrodes, and a head substrate, with arrays of read/write heads and pre-amp electronics (and sensing electronics). Different configurations of capacitive sensing and actuation electrode placement and designs are possible.

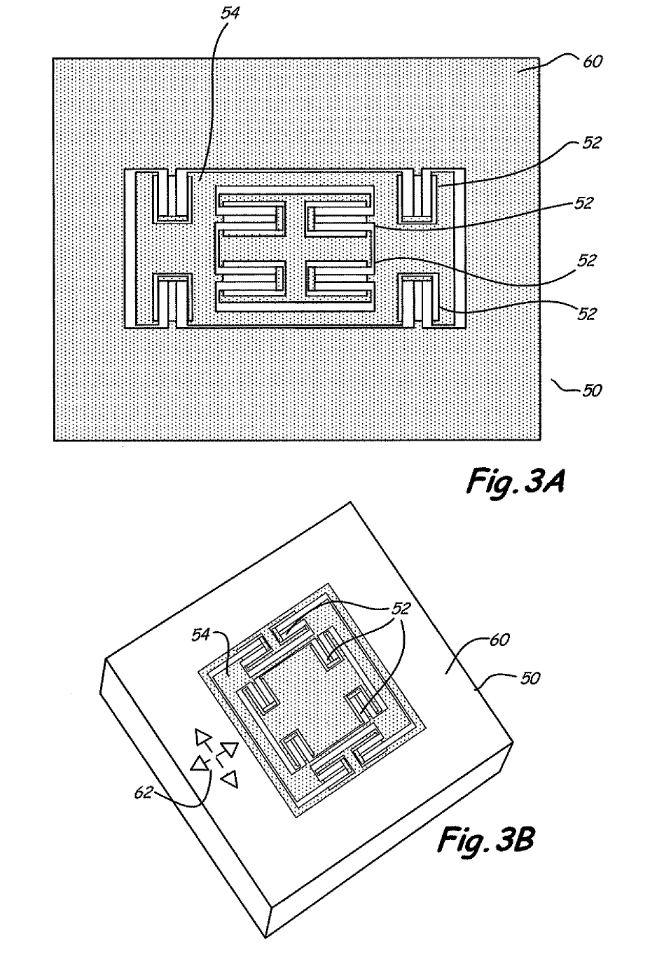

FIG. 3A is a top plan view and FIG. 3B is a perspective view of a rotor wafer 50 in accordance with one example configuration of the present invention. Rotor wafer 50 shows the media support springs 52 located in a central region. As used herein, “central” refers to regions which are spaced apart from an edge of the wafer 50. The central region is not necessarily in the center of the wafer 50; however, in some configurations the central region is positioned in the center. Further, in this configuration, the springs 52 and gimbals 54 are all positioned proximate one another. This leaves a large media region 60 which extends from the central region to the edge of the wafer. The media region is then configured to move in the direction indicated by arrows 62 shown in FIG. 3B.

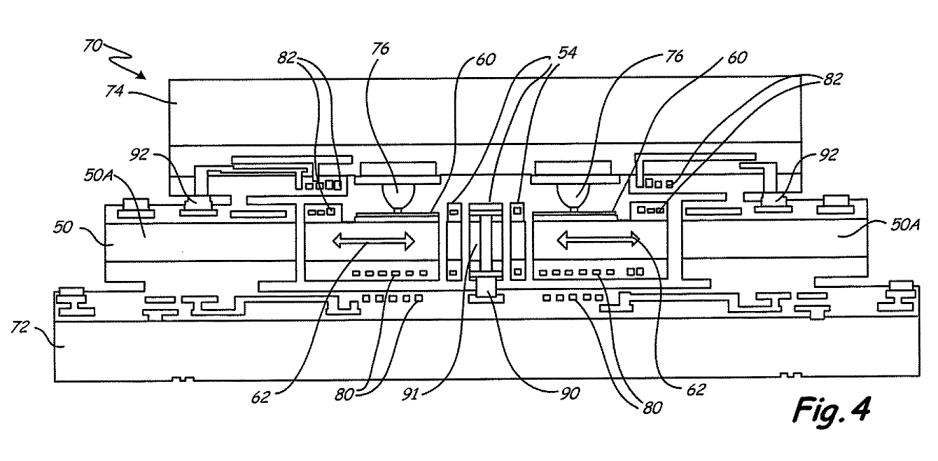

FIG. 4 is a side cross-sectional view of a storage system 70 including a mover in accordance with one embodiment of the present invention. Storage system 70 includes the rotor substrate 50 shown in FIGS. 3A and 3B, along with a stator substrate 72 and a head substrate 74. Head substrate 74 includes transducing heads 76 in accordance with any desired storage technology which are configured to interact with media 60. (Note that FIG. 4, and the other cross-sectional views, are not drawn to scale and show exaggerated features for viewing purposes). FIG. 4 also shows electrodes 80 used to actuate movement of the media portion of the rotor substrate as well as capacitive electrodes 82 used to sense position. An electrical connection 90 is provided between the stator substrate 72 and the gimbal 54 of rotor substrate 50. Similarly, electrical connections 92 are provided between the rotor substrate 50 and the head substrate 74.

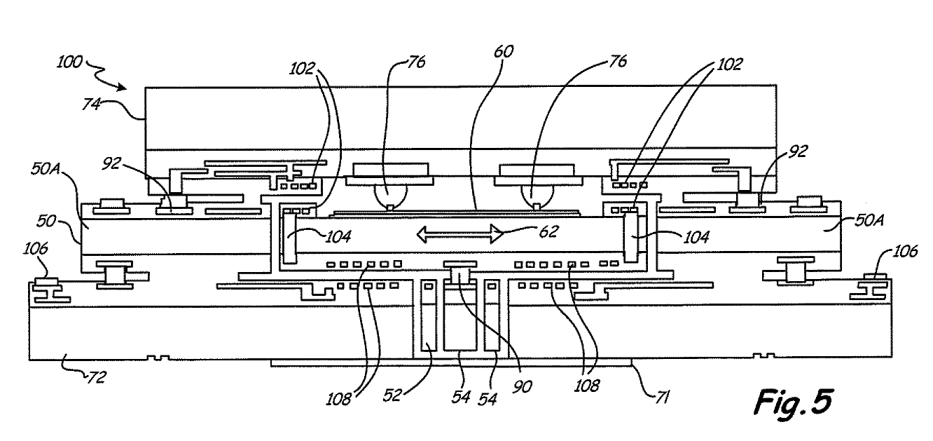

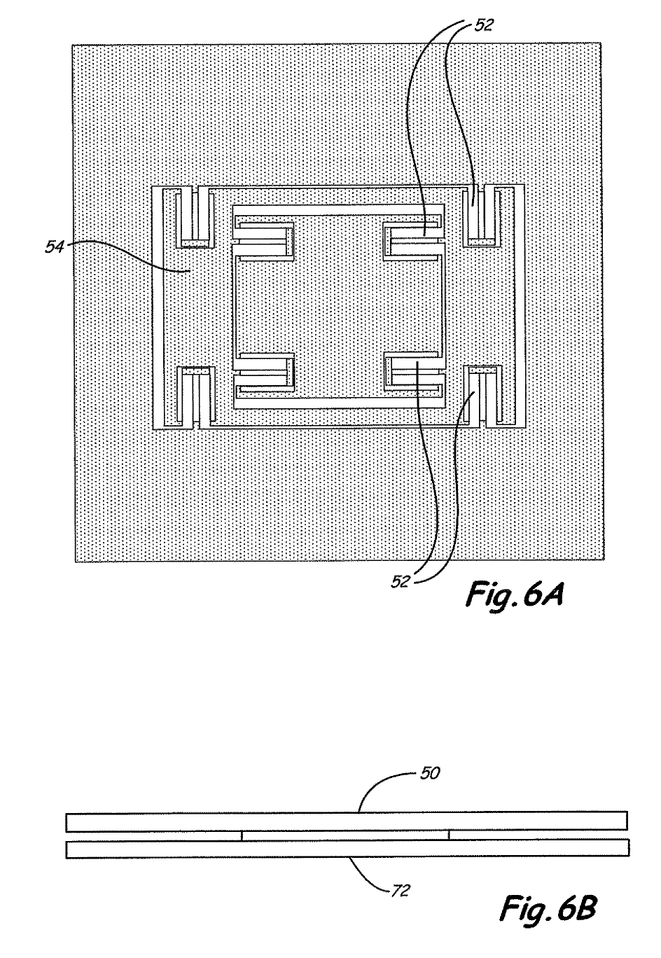

A second example configuration is illustrated in the cross-sectional view of FIG. 5 which shows storage system 100. Elements shown in FIG. 5 which are similar to those shown in FIG. 4 have retained their numbering. FIG. 6A is a top plan view of the stator wafer 72 showing springs 52 and gimbals 54 and FIG. 6B is a simplified side cross-sectional view showing rotor substrate 50 and stator substrate 72. In the configuration of FIGS. 5, 6A and 6B, the springs 52 and gimbals 54 are fabricated on the stator substrate 72 rather than on the rotor substrate 50. As the springs and gimbals 52 and 54 are now positioned on the stator substrate, the entire top surface of the rotor substrate 50 can be used to provide the media 60. With this configuration, the media area to chip area ratio may approach 100% thereby enabling a large recording capacity per unit of volume.

The rotor substrate 50 as shown in FIGS. 4 and 5 is composed of two parts: the moving media 60 and a stationary frame 50A enclosing the moving media. These two parts can be fabricated from a single wafer. Alternatively, the moving media 60 may be a separate chip from the frame 50A, which is attached to the stator substrate 72 with embedded springs and is sandwiched by the head-preamp chip. As shown in FIG. 5, location of 90 is the area where such attachment/bonding would be performed. To achieve a hermetic seal, the rotor frame 50A can be bonded to the stator 72 and head 74 substrates with a metal (or other material) bonding ring enclosing the movable media. An additional layer 71 is used to close the cavity created by the springs 52 and gimbal 54 on the stator substrate 72. FIG. 5 also shows capacitive sense electrodes 102, actuator electrodes 108, electrical vias 104 and electrical contacts 106.

While the mover designs illustrated here are electrostatically actuated, the present invention is not limited to electrostatic actuation. Furthermore, position sensing techniques other than capacitance sensing may be used. The mover design may be hermetically sealed depending on specific application requirements or method of implementation.

The above designs offer significant improvement in the area efficiency of the probe device. The first configuration may provide twice as much area as the prior art. The improved area efficiency has two-fold benefits. It offers more media area and more area for the electrostatic actuator.

Additional media area reduces the required areal density for the specific capacity for the device, thereby reducing development time for the probe product (or making it twice as competitive). Efficient use of silicon area also enables compact storage devices, thus allowing application of this storage technology in a larger variety of product markets.

The increased area provided by the present invention for the electrostatic actuator provides a linear improvement in the force that can be obtained from the actuator. This gain in force can be used to: reduce the voltage requirement, which affects the overall power consumption; reduce the risk of the voltage breakdown; provide additional force margin; or reduce the magnitude of the generated out-of-plane force, thereby providing a more robust device.

For the design shown in FIGS. 6A, 6B, an added benefit is that the media area is completely unaffected by mechanical design and optimization of spring and gimbal, thus allowing more design freedom.

For the mover 70, shown in FIG. 4, one advantage over prior art configurations arises from moving the spring structures toward the middle of the chip. By doing so, the amount of area employed for the gimbals and the anchoring is reduced.

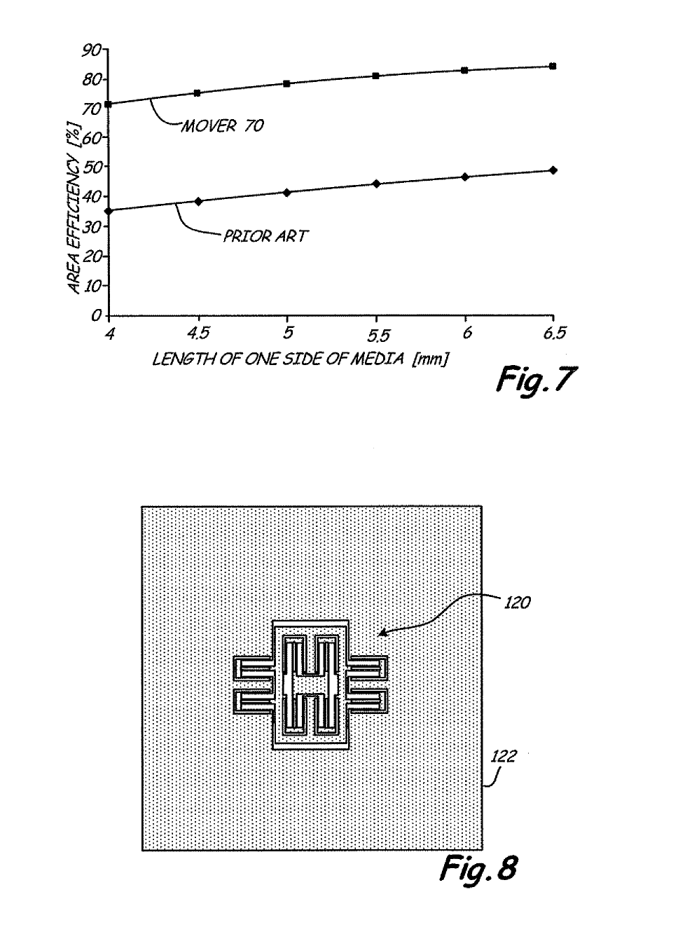

The area efficiency of the invention increases when larger form factors are considered. A comparison of the area efficiency of the mover 70 and a prior art mover is shown in FIG. 7. This gain in the area efficiency is because the area devoted to the suspension structure and the anchor stays unchanged for different form factors. From FIG. 7, it can be seen that the mover 70 offers almost twice as much useable area. This gain in the area efficiency has two benefits. One benefit is the improved area efficiency of the media. A second benefit is the improved area efficiency of the electrostatic actuator. By nearly doubling the area available for the electrostatic actuator, the force which may be obtained from the actuator is also nearly doubled. This additional force could be used to reduce the voltage requirement (thereby mitigating the risk of the voltage breakdown), reduce the power consumption, lower kz/kx ratio requirement (and the required spring aspect ratio), and/or increase the stability of the device. An additional benefit of a design configuration in which the suspension and gimbal are located in the center of the chip is that this provides reduced mass of gimbal structure and consequently increases the first resonance mode in at least in-plane axis.

Mover 70 may be in an array of 2×2 devices. Such a configuration is less susceptible to out-of-plane modes of vibration. One configuration includes 2×1, 2×1×2, etc.

Mover 70 provides the same in-plane stiffness and a very similar out-of-plane stiffness as the prior art movers. Although the gimbal structures are shorter and thus stiffer in mover 70, that benefit is diminished due to the specific boundary condition established through anchoring of the mover only at the central region. As a consequence, the rotor wafer 50 behaves as a fixed-free plate.

It should also be noted that the area efficiency of mover 70 is reduced if the mover is sealed. The sealing area occupies a region along the circumference. The overall area efficiency could be reduced by 15% or more.

The configuration of mover 100 shown in FIG. 5 offers further improvement in the area efficiency by removing the suspension structure from the rotor wafer 50 and by integrating it into the stator chip 72. A top plan view of the stator wafer 72 is shown in FIG. 6A, and a side view of the stator-rotor stack is shown in FIG. 6B. Consequently, the central portion of the stator chip 72 where the suspension structure is located, should be released (free to move relative the package). A portion of the released structure should be bonded to the media 60. As a result, 100% of the rotor wafer 50 is made available for the read/write. However, the overall area efficiency of this design is less than 100% if the mover 100 needs to be sealed, and the area efficiency could be 80% or lower.

An additional benefit of mover 100 is that the area efficiency of the media is independent of the layout of the suspension structure. The layout of the suspension structure affects only the area efficiency of the electrostatic actuator. Again, the higher the area efficiency of the electrostatic actuator the more force is available. The additional force can be traded for a larger anchoring area, which would then affect the dynamic properties of the device.

In addition to the spring design of FIG. 6A, other spring/gimbal designs may support the movers 70 and 100, such as the one shown in FIG. 8. FIG. 8 shows a spring/gimbal configuration 120 on a stator substrate 122. In a probe application, these two designs have uncoupled axes for in-plane motions and minimal out-of-plane motions. For other applications with different requirements, alternative springs may be used to support the mover architecture.

The suspension structure can be based on the folded-beams structure as shown in FIG. 6A. This folded-beam structure includes four high aspect ratio beams. They are grouped in two sets of two beams. Beams in each set are arranged to function in parallel, while the two sets are connected to function in series. One end of each set is connected to a structurally rigid member that interconnects two sets. The other end of each set can be connected to the anchoring area, the gimbal structure, or the media. In such an arrangement, the folded-beam structure allows for relative motion, along one axis, of two distant ends of the two sets of beams. These beams may provide mechanical functions as described, but they may also serve as electrical interconnects between the stationary and fixed portion of the rotor layer 50. The beams may be doped or metalized to provide low-resistance electrical paths. Design of the springs should take into consideration the stiffness or stress effect of the doping or added conductive and insulating layers.

The mover of the present invention can use different arrangements of the beams. For example, the folded-beam structure could use only two beams, instead of four; it could use more than four beams; the folded-beam structures could be arranged in such way that they are not symmetrically arranged along both x- and y-axis; or, the suspension structure could utilize another beam arrangement, different from the folded-beams structure.

Because the mover 70 and mover 100 both have support spring structures in the center, the rotational stiffness is reduced. However, several design optimizations are possible to achieve greater rotational stiffness. One example design includes moving the folded springs slightly away from the center to the outer edges of the mover. The spring/gimbal structure in this case would occupy a larger area. However, for the mover 100, there is no impact on the media area efficiency, although the actuator area efficiency is reduced. The area of the larger spring/gimbal structure may not be completely lost as some of the area may be used for actuation (or capacitive position sensing).

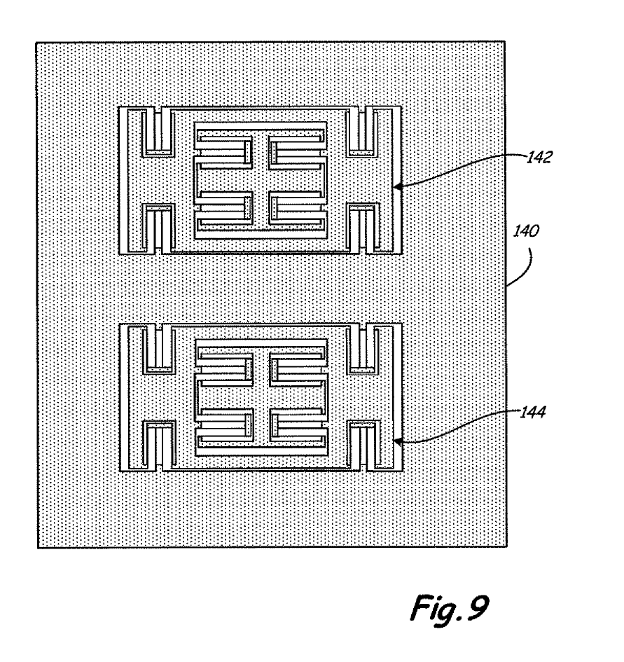

FIG. 9 is a top plan view of a wafer 140 including two spring/gimbal supports 142, 144 in a center region of the wafer 140. The use of multiple spring/gimbal supports 142, 144 may also improve dynamic performance. Because the media rotor is now anchored not at the center but at two separated locations, the rotational stiffness should be significantly improved. This approach is well suited for the design of mover 100 where the media area efficiency is independent of the mover spring and gimbal design. In this case, the in-plane stiffness of each spring/gimbal 142, 144 block may be reduced as needed to accommodate the maximum in-plane force achievable by the electrostatic actuator. As needed, the outer dimensions of the structure may be chosen to be rectangular (rather than square) to optimize the performance in both axes. Further reduction of stroke, and thus the size of the springs, may also allow more than the two spring support blocks shown. For instance, a tripod arrangement may provide large rotational stiffness about both the x- and y-axes.

In addition, two or more smaller MEMS movers may be joined into a large MEMS mover. In this case, the large mover structure will be anchored in multiple points (distributed as needed) to yield improved dynamic performance. However, tradeoffs with system architecture must be carefully considered.

One fabrication challenge for the design of mover 70 is electrical routing to the capacitive sensing electrodes and the actuation electrodes on the rotor 50. This challenge may not necessarily apply to all probe storage applications or micro-positioner or actuator applications.

For the case where capacitive sensors are positioned between the media rotor surface 50 and head array surface 74 (FIG. 4), the sensor signal on the rotor must be routed through the springs. As the fixed anchor is in the center, the electrical connection must be routed first through the center and then further through the suspension structure. When the sensors are between the media 50 and head 74 wafers, the signals must be routed through the media wafer 50 to the side nearest the head 74 wafer.

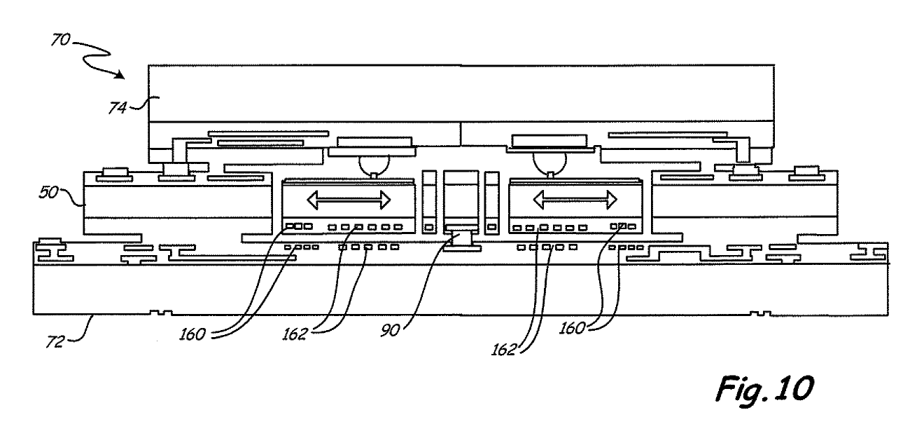

One method is to create through-vias 91 or side-wall interconnects on the fixed center anchor of the rotor substrate 50 shown in FIG. 4. Another solution is to place capacitive sensors 160 between the stator 72 and rotor 50 substrates near actuators 162, as shown in FIG. 10. One benefit of this approach is that through-vias or side-wall interconnects would no longer be required for the capacitive electrodes. All the capacitive sensor signals are carried to the stator substrate 72 through the springs and then conductive (metal) contacts 90 through the center anchor, the same way as the actuation electrode signals. Another benefit of this approach is that the available media area would be her increased. The tradeoff is that the parasitic capacitance is increased. Sensing detection electrodes are situated on the stator substrate 72, which may not have integrated electronics. Therefore, added parasitic capacitance (from routing and wire bonding) may reduce the sensing resolution compared to the configuration in FIG. 4.

A third option is to use a circuit implementation in which the capacitive electrodes on the rotor may be grounded. With such a configuration, the electrodes can comprise the bulk rotor substrate 50 which is made conductive through doping, thereby avoiding any metal routing or through-vias. In this case, the capacitive sensor may be located between the head and media surfaces as in FIG. 6 to achieve best electrical performance, or located between the rotor and stator substrate to maximize media area on the rotor as in FIG. 10.

Fabrication challenges for the mover 100 of FIG. 5 include electrical routing to the capacitive sensing electrodes and the actuation electrodes on the rotor and hermetic sealing of the MEMS mover. These two challenges may not necessarily apply to all probe storage applications or micro-positioner or actuator applications. There are many approaches to fabricate each of the layers of the MEMS system. There are also many solutions to these two challenges.

As shown in FIG. 5, the capacitance sensor electrodes 102 on the rotor 50 are routed through the through-wafer vias 104, then through the center anchor connection 90, then the springs, and finally to the bondpad 106 on the edge of the stator substrate 72. This approach is a realistic implementation because noise, parasitic capacitance, and resistance requirements for these signals are not stringent. However, this approach leads to added cost of through-wafer vias. One solution is to put the capacitive sensing electrodes between the rotor and stator substrates (instead of the head and rotor substrates) as discussed above so that the need of through-wafer vias is eliminated. One tradeoff of this approach is that media area would be increased, but parasitic capacitance may also be increased. Alternatively, the capacitance sense electrodes on the rotor may be shorted to the rotor substrate 50, thus eliminating the vias, routing, and bondpads. Similar, the actuator electrodes on the rotor may also be grounded.

Hermetic sealing of the MEMS mover may be important in some configurations. Large out-of-plane damping is desirable for the mover to withstand operating shock and vibration. Squeeze-film damping between the layers of the MEMS structure may offer needed out-of-plane damping and thus a stable volume of gas is required inside the MEMS system. Secondly, protection of the media interface by maintaining a clean environment (free of undesirable debris, chemicals, and moisture) is important to read/write physics and reliability. For ease of manufacturing and assembly, a sealed MEMS device enables simple handling during the wafer dicing process and packaging assembly process. The requirement for hermeticity is not essential for all applications.

For hermetic sealing of the MEMS mover, many approaches are possible. As shown in FIGS. 4 and 5, the rotor substrate 50 is composed of two parts, the moving media and a stationary frame enclosing the moving media. The stationary or fixed frame serves as a spacer to define the height of the cavity for the media rotor. It may be bonded to the stator rotor 72 and eventually to the head chip 74 using a seal ring of various materials or other bonding methods. Besides the seal ring, this fixed frame may also have electrical routing, bondpads, and even through-vias to enable electrical interconnection to the moving rotor or head array chip.

The two rotor parts as described can be fabricated from a single wafer. In this case, media may be first deposited on a silicon wafer A large gap is then etched between the media rotor and the fixed frame area. This gap must be adequately large to accommodate the in-plane stroke with some margin. The media rotor may remain to be attached to the frame prior to bonding to the stator substrate via tethers to be eliminated later. Otherwise, a carrier wafer may be used to hold the media rotor and the fixed frame together during the silicon gap etch and wafer bonding. Alternatively, the media wafer is bonded to the stator wafer prior to the gap etch/frame formation. Fabricating both parts of the rotor substrate using a single wafer as described helps to ensure that the relative position of the frame and the media rotor is precise.

Another approach is to create the fixed frame and the moving media separately. In this case, the frame and the media substrate would be attached to the stator substrate 72 in two separate steps. One benefit of this approach is that the bonding process for the fixed frame may be independently optimized from the bonding process for the media substrate. Further, fabrication of the media substrate would be simplified because the media would not need to be protected against harsh silicon etching chemicals or conditions. Media “chips” may be bonded individually to the center anchor on the rotor or multiple media “chips” can be bonded simultaneously. This approach would reduce media production cost because all of the media wafer surface may be dedicated to media material (instead of partially to gaps or springs or fixed frame). However, a total of four separate wafers are required for this approach.

Note that the frame of the rotor 50 need not be first bonded to the stator 72 and then bonded to the head substrate 74. One alternative is to attach the frame first to the head substrate 74. Then the “stacked” head substrate with the frame is bonded to the stator substrate 72.

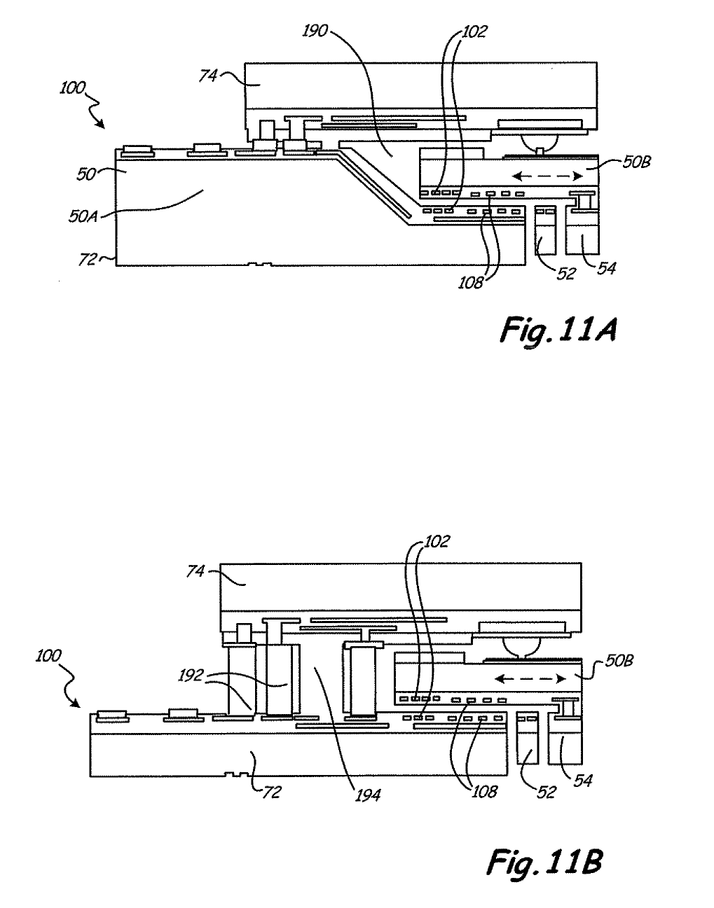

Alternatively, the fixed spacer frame can be fabricated as part of the stator substrate 72 (FIG. 11A) or be deposited on the stator substrate or head array substrate 72 (FIG. 11B). In the first case, a “pit” 190 with a depth corresponding to the thickness of the media rotor 50B may be etched into the stator substrate 72 (using a low cost anisotropic wet etchant). The DRIE step for spring definition may take place prior or after the “pit” etch. One benefit of this approach is that the bonding step for the spacer frame 50A is eliminated. However, lithography of the electrodes on the stator may become more difficult. In the latter case, the stationary spacer frame may be made of plated metal or deposited polymer (such as SU8). The choice of material will depend on the required degree of robustness, hermedicity, and cost. FIG. 11B shows a configuration in which seal rings/interconnects 192 are used with a spacer 194.

A method is also needed to seal the bottom of the MEMS wafer stack. Because the springs of mover 100 are located on the stator substrate 72, gaps in the spring structures allow airflow into the MEMS mover cavity through the stator wafer 72. Sealing of this opening may occur in many points of the fabrication or assembly process. Tradeoffs of reliability, yield, cost, and development time must be considered to evaluate many possible schemes. The scheme may also be influenced by how the springs are fabricated on the stator, how the rotor substrate is processed, and how the different wafers are bonded together.

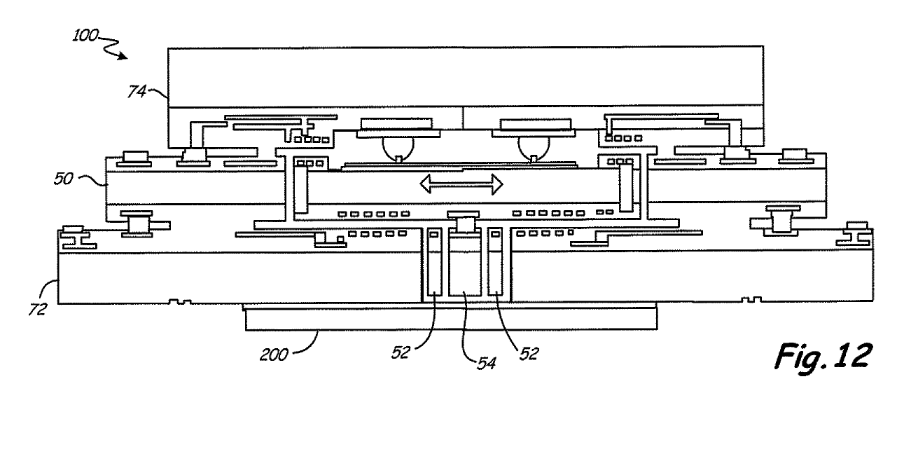

There are many possible methods to create a sealed cavity despite the spring structure. One method is to create a stator substrate with a sealing layer 200 shown in FIG. 12 as one subcomponent. As an example, an SOI wafer may be used as a starting material for the stator/spring substrate. Then the spring 54 may be etched from one side with the oxide layer as an etch-stop (either before or after deposition of other metal or insulation layers necessary for electrical interconnection). The media rotor is then bonded to the stator substrate 72. The oxide layer may then be removed as a sacrificial layer eventually in order to free the spring structure.

Alternatively, instead of using an SOI wafer as the stator substrate starting material, a silicon wafer, as a fourth layer, may be bonded to the stator substrate to provide sealing. This approach may likely added extra thickness to the stack but may be mitigated via wafer grinding or thinning technology.

Alternatively, the stator substrate opening may be sealed using a “membrane”. The bottom sealing “layer” may be made of a single or multiple layers of material as needed to achieve desired rigidity, robustness, filtration, and degree of hermedicity. This layer may be deposited via microfabrication techniques or traditional manufacturing techniques. This bulk layer may be an adhesive material to attach the MEMS module to a circuit substrate.

An example method to create a cavity covered by a membrane is as follows: a shallow cavity may be etched in a Si wafer as the starting material of the stator substrate. The cavity is then refilled with a sacrificial material, such as oxide, photoresist, metal, etc. If needed, the surface may be polished flat. A layer serving as the sealing layer would be deposited. Then metallization/insulation and the DRIE processing of the spring/gimbal structure would be carried out on the opposite side of the wafer. The rotor may then be bonded to the stator, followed by the removal of the sacrificial layer through a wet or dry chemical etch. If necessary, an etch hole/pattern may be added to the rotor to facilitate sacrificial etching. Alternatively, the sacrificial material is removed prior to rotor bonding. However, a special process is required to bond the rotor to the freely suspended pedestal structure.

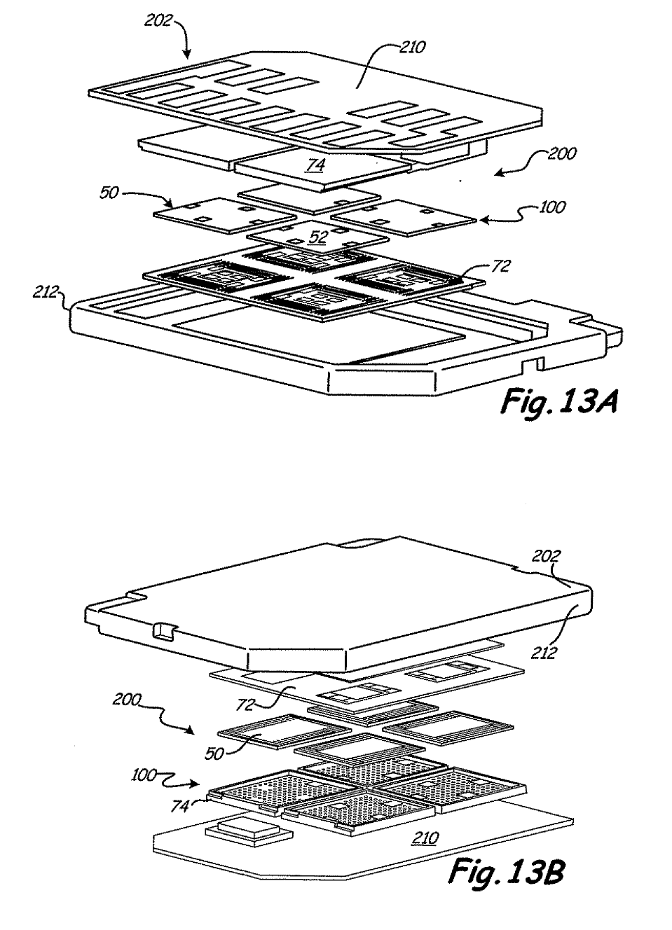

FIGS. 13A and 13B are illustrations of an array 200 of 2×2 probe modules with movers 100 packaged inside an RS-MMC package 202. FIG. 13A is a bottom and 13B is a top exploded perspective view. Each MEMS module cell size is 6.71×5.6 mm². Surrounding the media rotor is a width of 250 um reserved for a gap to enable actuation stroke and a seal ring. In this configuration, the mover 100 achieved an area efficiency of 85%, with actual media area of 30.6 mm². In contrast, if a prior art mover or mover 70 would be used, the corresponding values for area efficiency and media area would be 38% and 13.8 mm² and 52% and 18.7 mm², respectively.

As shown, the stator substrate 72 for multiple movers are joined as one to simplify routing or assembly. The media rotor and head chip may be bonded to a large stator wafer, which is then diced into 2×2 arrays. Alternatively, the wafer may be diced into separate individual MEMS modules or 1×2 modules or other combinations.

Capacitive sensors may be located on the same surface of the media substrate as shown, with matching electrodes on the heads chip. Alternatively, the media area may be maximized by placing the capacitance sensors on the same surfaces as the actuation electrodes, as discussed in previous paragraphs.

The “ring” for sealing the media rotor as shown is part of the head chip 74. The seal ring may also be part of the stator substrate (bonded or deposited or integrated) and may be created in a number of ways as described in previous paragraphs.

As shown the MEMS chips and the support electronics, which may include the System On a Chip (SOC) and high-voltage supply and drivers, are mounted on a circuit substrate 210 (with wire traces and other passive components (not shown)). The support electronics are stacked and are located on the side of the 2×2 MEMS arrays. Other possible configuration may include, but are not limited to 1×2 arrays of MEMS chips on either side of the support electronics.

As shown, the head chip is directly mounted on the circuit substrate. Alternatively, the layer stack of the MEMS module may be reversed so that the stator substrate is directly mounted on the circuit substrate instead. The assembly array is sealed in a housing 212.

The present invention provides a number of features including:
1. A method of improving the area efficiency of the probe device by defining the position of the suspension structure in the middle of the rotor wafer.
2. A method of improving the area efficiency of the probe device by defining the position of the suspension structure on the stator wafer.
3. A method of improving the electrostatic actuator area efficiency of the probe device by using different arrangements of the suspension structure.
4. A method of providing an increase in the force that is available from the electrostatic actuator, through providing improved area efficiency of the electrostatic actuator.
5. A method of providing an increase in signal that is available from the capacitive sensor, through devoting more area to the capacitive sensor, possible through improved area efficiency.
6. A method of reducing the voltage requirements for the electrostatic actuator used for probe device, through providing improved area efficiency of the electrostatic actuator.
7. A method of reducing the risk of the voltage breakdown of the dielectric insulator due to reduced voltage requirement.
8. A method of reducing the power consumption of the probe device by reducing the voltage requirement.
9. A method of improving the out-of-plane stability of the device through reducing the force generated by electrostatic actuator.

Although the present invention has been described with reference to preferred embodiments, workers skilled in the art will recognize that changes may be made in form and detail without departing from the spirit and scope of the invention. As used herein, the term “suspension” includes any combination of springs and gimbals. “Center” and “interior” portions refer to portions of the mover in which the moving portion (such as the media) is positioned around the suspension or in which the moving portion is above or below the suspension. “Moving substrate” includes the portion(s) of a substrate which move, such as the rotor, media, or other portion. “Suspension” includes an apparatus which couples two substrates together but allows relative movement therebetween.

What is claimed is:

1. A micromachined mover, comprising:
a moving substrate;
a stator substrate;
a suspension configured to couple the moving substrate to the stator substrate and allow relative movement therebetween in a plane of the substrates; and
wherein the suspension is positioned on an interior portion of the substrates.

2. The apparatus of claim 1 wherein the suspension is positioned proximate a center of the moving substrate.

3. The apparatus of claim 1 wherein the suspension couples to the moving substrate to the stator substrate and allows relative movement therebetween.

4. The apparatus of claim 1 including a storage medium and a transducing head coupled to the moving substrate and the suspension arranged to provide relative movement therebetween in the plane of the substrates.

5. The apparatus of claim 4 wherein the transducing head is carried on a head substrate.

6. The apparatus of claim 4 wherein the storage medium is carried on the moving substrate.

7. The apparatus of claim 1 wherein the suspension is formed in the moving substrate.

8. The apparatus of claim 1 wherein the suspension is formed in the stator substrate.

9. The apparatus of claim 1 including a second suspension and wherein the suspensions are surrounded by the moving substrate.

10. The apparatus of claim 1 including capacitance position sensing electrodes and actuator electrodes positioned on the moving substrate and the stator substrate.

11. The apparatus of claim 1 including a seal which seals the moving substrate.

12. The apparatus of claim 7 including a seal which seals the suspension.

13. The apparatus of claim 1 wherein the stator substrate includes a depression formed therein and the moving substrate is positioned in the depression.

14. A method of moving a micromachined moving substrate, comprising:
providing a stator substrate;
providing a suspension which allows movement between the moving substrate and the stator substrate;
coupling the moving substrate to the stator substrate with the suspension, wherein the suspension is surrounded by the moving substrate; and
moving the moving substrate relative to the stator substrate.

15. The method of claim 14 wherein the suspension is positioned proximate a center of the moving substrate.

16. The method of claim 14 including providing a storage medium on the moving substrate and a transducing head coupled to the moving substrate and the suspension arranged to provide relative movement therebetween in the plane of the substrates.

17. The method of claim 16 wherein the transducing head is carried on a head substrate.

18. The method of claim 14 including forming the suspension in the moving substrate.

19. The method of claim 14 including forming the suspension in the stator substrate.

20. The method of claim 14 including a seal which seals the moving substrate.

21. The method of claim 14 including forming a depression in the stator substrate and positioning the moving substrate in the depression.
